(19) United States
(12) Patent Application Publication
(10) Pub. No.: US 2021/0169046 A1
(43) Pub. Date: Jun. 10, 2021

(54) SYSTEM FOR MOUNTING AND DISPLAYING A FLAG, AND RELATED AND METHODS

(71) Applicant: Christopher Carver, Enumclaw, WA (US)

(72) Inventor: Christopher Carver, Enumclaw, WA (US)

(21) Appl. No.: 16/950,592

(22) Filed: Nov. 17, 2020

Related U.S. Application Data
(60) Provisional application No. 62/936,871, filed on Nov. 18, 2019.

(51) Int. Cl. A01K 13/00; A01K 27/00; G09F 17/00

(52) U.S. Cl. CPC A01K 13/006; G09F 2017/0066; G09F 17/00; A01K 27/006

(57) ABSTRACT

A system for mounting and displaying a flag on an animal includes: a flag, a mast and a coupler. The flag includes any desired design and often includes the colors and design associated with a specific football team. The mast is attached to the flag and is operable to hold the flag in a position away from an animal's body when the system is coupled with an animal. The coupler is attached to the mast and is operable to couple the mast to an animal and position the mast such that the mast extends away from the animal. With the coupler and mast, one can releasably couple the system to an accessory worn by an animal such as a collar, a shirt, a sweater, a rain slick, or stockings, or to the animal itself such as the animal's tail or back. In this manner, one can couple the system to a variety of different animal's each of which have different body shapes and/or sizes.

### CROSS-REFERENCE TO RELATED APPLICATIONS AND INCORPORATION BY REFERENCE

This application claims priority from U.S. Provisional Patent Application 62/936,871 filed 18 Nov. 2019 and titled “Wag-a-Flag”. This application also incorporates by this reference the entirety of U.S. Provisional Patent Application 62/936,871.

### BACKGROUND

There are many ways that fans of sport's teams can show their loyalties. A common way of doing this is to wear a copy of a jersey of a player who plays for the team. Another common way of doing this is to place a sticker showing a team's colors and/or icon on an object.

Sometimes, fans show their sport's team loyalties by decorating their pet such as a dog, a cat, a bird, a snake, a rabbit, and/or a guinea pig. This is typically done by having the pet wear a collar, a shirt, a sweater, a rain slick, and/or stockings that include one or more references to a sport's team. Unfortunately, such attire is typically configured to fit an animal having a specific body shape and a specific size. Thus, if one has two or more pets, then one has to purchase two or more sets of attire—one that fits one of the pets and another one that fits another of the pets.

Thus, there is a need for a system that allows one to decorate his/her pet or pets regardless of the pet's shape and size.

### SUMMARY

In one aspect of the invention, a system for mounting and displaying a flag on an animal includes: a flag, a mast and a coupler. The flag includes any desired design and often includes the colors and design associated with a specific football team. The mast is attached to the flag and is operable to hold the flag in a position away from an animal's body when the system is coupled with an animal. The coupler is attached to the mast and is operable to couple the mast to an animal and position the mast such that the mast extends away from the animal.

With the coupler and mast, one can releasably couple the system to an accessory worn by an animal such as a collar, a shirt, a sweater, a rain slick, or stockings, or to the animal itself such as the animal's tail or back. In this manner, one can couple the system to a variety of different animal's each of which have different body shapes and/or sizes.

In another aspect of the invention, a method for mounting and displaying a flag on an animal includes: 1) coupling to an animal a mast of a system that is attached to a flag of a system; and 2) positioning the mast such that the mast extends away from the animal.

### BRIEF DESCRIPTION OF THE DRAWINGS

FIG. 1 shows a perspective view of a system for mounting and displaying a flag on an animal, according to an embodiment of the invention.

FIG. 2 shows a view of a coupler of the system shown in FIG. 1, according to an embodiment of the invention.

FIG. 3 shows the system shown in FIG. 1 mounted on an animal, according to an embodiment of the invention.

### DETAILED DESCRIPTION

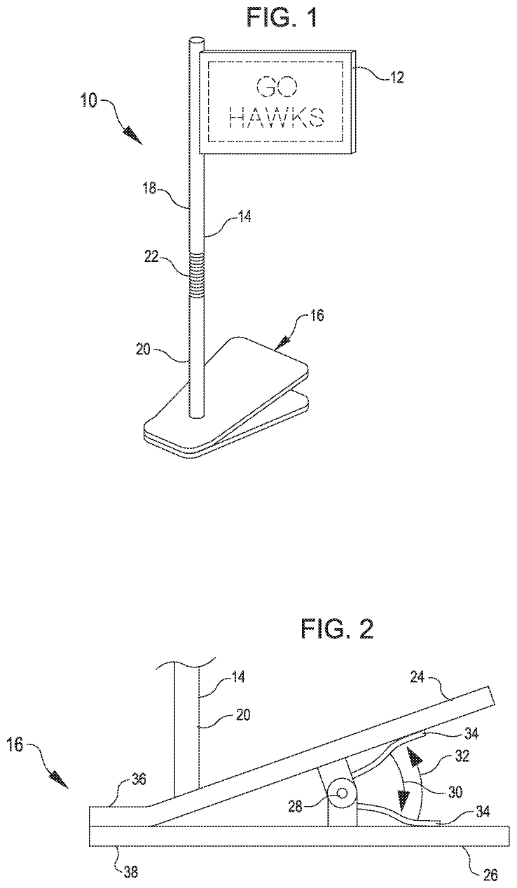

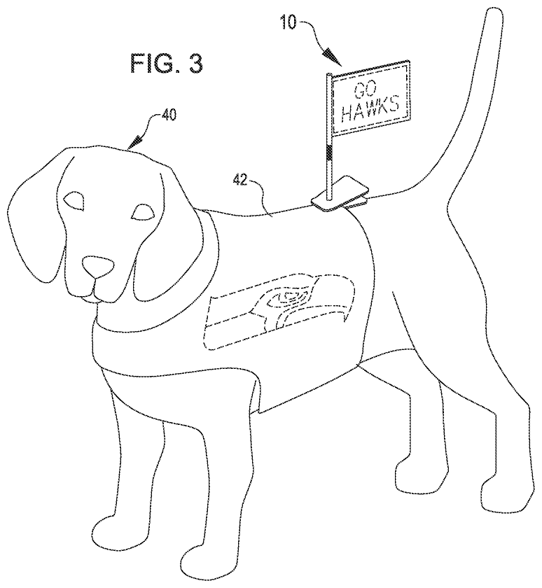

FIG. 1 shows a perspective view of a system 10 for mounting and displaying a flag on an animal, according to an embodiment of the invention. The system 10 includes a flag 12, a mast 14, and a coupler 16. The flag 12 may represent a country, a state, a brand for a product or service, and/or a sport's team. For example, as shown in FIG. 3, the flag represents the Seattle Seahawks of the North American National Football League and includes the phrase, “Go Hawks!”. The mast 14 couples the flag 12 with the coupler 16, and positions the flag 12 away from the animal's body when the system 10 is worn by an animal. The coupler 16 releasably couples the mast 14, and thus the flag 12, with an animal or an accessory worn by the animal, such as a collar, a shirt, a sweater, a rain slick, or stockings.

With the coupler 16 one can releasably couple the system 10 to an accessory worn by an animal or to the animal itself, such as the animal's tail or back. Thus, one can couple the system 10 to a variety of different animal's each of which may have a different body shape and/or a different body size.

The flag 12 may be sized and configured as desired. For example, in this and other embodiments the flag 12 includes a conventional cloth fabric that extends, when fully unfurled, five inches away from the mast 14, and three inches along the mast 14. At this size and with this fabric, the flag 12 will not unduly burden a small pet such as a dog, cat or guinea pig while the system 10 is mounted to the animal and the animal walks or runs around. Other embodiments of the flag include a different size and/or a different material, such as a material that is water proof or at least water resistant, and/or battens to help keep the flag 12 extending away from the mast 14 and easily recognizable by anyone.

The mast 14 may be sized and configured as desired, too. For example, in this and other embodiments the mast 14 includes a cylindrical wooden pole having a diameter of ¼ of an inch and six inches long. More specifically, the mast 14 includes a first end 18 that the flag 12 is attached to, a second end 20 that the coupler 16 is attached to, and a spring 22 disposed between the first and second ends 18 and 20, and that couples the first end 18 with the second end 20. By lying between and coupling the first and second ends 18 and 20, the spring 22 allows the first end 18, and thus the flag 12, to move relative to the second end 20, and thus the coupler 16. This helps the system 10 stay mounted to the animal while the animal moves about, and helps the mast 14 maintain the position of the flag 12 away from the animal's body during such activities.

Other embodiments are possible. For example, the mast 14 may have a pole that is longer or shorter than six inches, and made of a material other than wood such as plastic. For another example, the mast 14 may not include the spring 22. For yet another example, the spring 22 may be stiff and only allow the first end 18 to move a little bit relative to the second end 20, or the spring 22 may be flexible and allow substantial movement of the first end 18 relative to the second end 20.

Still referring to FIG. 1, the flag 12 may be attached to the mast 14 in any desired manner. For example, in this and other embodiments the flag 12 is fixed to the mast 14 with staples. In other embodiments, the flag 12 may be releasably attached to the mast 14. For example, the flag 12 may include a sleeve or sock sized and configured to receive the first end 18 of the mast 14. For another example, the flag 12 may include one or more laces that one can use to tie the flag 12 to the mast 14. In such embodiments, the one or more laces would wrap around the mast 14 and would be tied to either a corresponding lace that wraps around the mast 14 in another direction, or to a loop located on the flag adjacent the mast 14.

FIG. 2 shows a view of a coupler 16 of the system 10 shown in FIG. 1, according to an embodiment of the invention. The coupler 16 releasably couples the mast 14, and thus the flag 12, with an animal or an accessory worn by the animal, and allows the system 10 to be mounted on any animal such as a dog (as shown in FIG. 3), a cat, a bird, a snake, a rabbit, and/or a guinea pig.

The coupler 16 may be configured as desired to perform this function. For example, in this and other embodiments the coupler 16 includes a first jaw 24 pivotally coupled with a second jaw 26 that together pinch to hold the mast 14 to an animal. More specifically, the first jaw 24 and the second jaw 26 are coupled together with a pin 28 that allows each jaw 24 and 26 to rotate relative to the other jaw 26 and 24 about the axis of the pin 28 as shown by the arrows labeled 30 and 32. The coupler 16 also includes a spring 34 to pinch and maintain the pinch of the animal or accessory worn by the animal. In this and other embodiments the spring 34 is a torsion spring that has each of its ends in contact with a respective one of the jaws 24 and 26 to urge each end 36 and 38 of a respective one of the jaws 24 and 26 against each other. Depending the size, weight, and configuration of the system 10—i.e. the size, weight, and configuration of the mast 14, flag 16, and coupler 16—the spring 34 may have a high spring constant to more securely mount the system 10 to the animal, or a low spring constant to allow the system to more easily detach from the animal when needed. A high spring constant may be desirable when the system 10 is to be mounted to a large, active dog, for example, that could easily cause the system 10 to prematurely detach while running or jumping. A low spring constant may be desirable when the system 10 is to be mounted to a small, less active dog, for example, that could become unduly burdened by the system 10 if the system 10 becomes snagged on something.

Other embodiments are possible. For example, the coupler 16 may be an adjustable strap that is configured to wrap around the tail or hindquarters of an animal. In this embodiment, the strap may also include a saddle contoured to match the curvature of an animal's tail or back to help the mast 14 position the flag 12 away from the animal's body. For another example, the coupler 16 may be built-into or permanently fixed to the sweater 42 or any other accessory worn by an animal.

The mast 14 may be attached to the coupler 16 in any desired manner. For example, in this and other embodiments the mast 14 is fixed to the coupler 16. More specifically, the second end 20 of the mast 14 does not move relative to the first jaw 24 of the coupler 16. In other embodiments, the second end 20 may rotate relative to the first jaw 24 to allow mast 14 to automatically position the flag 12 in alignment with the direction of the wind experienced by the flag 12. In still other embodiments, the second end 20 may be releasably attached to the first jaw 24 to allow one to quickly change the mast 14 and flag 12 configuration of the system 10.

FIG. 3 shows the system 10 shown in FIG. 1 coupled with a dog 40, according to an embodiment of the invention. Here the system 10 is mounted to a sweater 42 that the dog 40 wears. In other embodiments the system may be mounted to a collar worn by the dog 40, or a belt worn by the dog 40 around his hindquarters.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A system for mounting and displaying a flag on an animal, the system comprising:
a flag;
a mast attached to the flag and operable to hold the flag in a position away from an animal's body when the system is coupled with an animal; and
a coupler attached to the mast and operable to couple the mast to an animal and position the mast such that the mast extends away from the animal.

2. The system of claim 1 wherein the flag includes colors and a graphic design that identifies a football team.

3. The system of claim 1 wherein the flag includes colors and a graphic design that identifies a basketball team.

4. The system of claim 1 wherein the mast includes a first end where the flag is attached, and a second end where the coupler is attached.

5. The system of claim 1 wherein the mast has a cylindrical shape and is six inches long.

6. The system of claim 1 wherein the mast includes a spring operable to allow a portion of the mast to move relative to another portion of the mast. The system of claim 1 wherein the mast includes a first end, a second end, and a coil spring disposed between the first and second ends and that couples the first end with the second end.

8. The system of claim 1 wherein the coupler is operable to hold the mast to a collar of an animal.

9. The system of claim 1 wherein the coupler is operable to hold the mast to a shirt worn by an animal.

10. The system of claim 1 wherein the coupler is operable to hold the mast to a tail of an animal.

11. The system of claim 1 wherein the coupler includes a first jaw pivotally coupled with a second jaw that together pinch to hold the mast to an animal.

12. A method for mounting and displaying a flag on an animal, the method comprising:
coupling to an animal a mast of a system that is attached to a flag of a system; and
positioning the mast such that the mast extends away from the animal.

13. The method of claim 12 wherein coupling the mast to an animal includes coupling the mast to the animal's collar.

14. The method of claim 12 wherein coupling the mast to an animal includes coupling the mast to a shirt that the animal is wearing.

15. The method of claim 12 wherein coupling the mast to an animal includes coupling the mast to the animal's tail.

16. The method of claim 12 wherein coupling the mast to an animal includes a first jaw of a coupler of the system pinching with a second jaw of the coupler.

17. The method of claim 12 wherein positioning the mast includes positioning the mast such that the mast extends up away from the animal's back.

18. The method of claim 12 wherein positioning the mast includes positioning the mast such that the mast extends up above the animal's neck.

19. The method of claim 12 wherein positioning the mast includes positioning the mast such that the mast extends away from the animal's tail.
